(19) United States
(12) Patent Application Publication
(10) Pub. No.: US 2013/0144633 A1
(43) Pub. Date: Jun. 6, 2013

(54) ENFORCEMENT AND ASSIGNMENT OF USAGE RIGHTS

(71) Applicants: Humberto Lezama Guadarrama, (US); Onur Cobanoglu, (US); David Mowatt, Dublin (IE); Goksel Genc, (US); David Åhs, Dublin (IE); Viswanathan Rathinavelu, (US); Eray Chou, (US); David LeBlanc, (US); Terry Farrell, Dublin (IE)

(72) Inventors: Humberto Lezama Guadarrama, (US); Onur Cobanoglu, (US); David Mowatt, Dublin (IE); Goksel Genc, (US); David Åhs, Dublin (IE); Viswanathan Rathinavelu, (US); Eray Chou, (US); David LeBlanc, (US); Terry Farrell, Dublin (IE)

(73) Assignee: Microsoft Corporation, Redmond, WA (US)

(21) Appl. No.: 13/308,746

(22) Filed: Dec. 1, 2011

(51) Int. Cl. G06Q 30/06

(52) U.S. Cl. 705/1.1

(57) ABSTRACT

Systems and methods are disclosed that assign and/or enforce usage rights for a software application. Further, the systems and methods assign and/or enforce usage rights for a software application with one or more users by decoupling the identity of the person who purchases the application from the actual users of the application. Additionally, the systems and methods provide for centralized built-in user assignment with support for multiple applications.

### BACKGROUND

Assignment and enforcement of usage rights (e.g. licenses) for software applications is complex and costly and often requires software providers to write their own licensing systems. Additionally, allowing multiple users to use one application based on the purchase of the application by one user while maintaining assignment and enforcement of usage rights is also a costly and complex endeavor. It is with respect to this general environment that embodiments of the present disclosure have been contemplated.

Although specific problems have been addressed in this Background, this disclosure is not intended in any way to be limited to solving those specific problems.

### SUMMARY

Embodiments of the present disclosure relate to systems and methods for assigning and/or enforcing usage rights for a software application. Further, the present disclosure relates to systems and methods for assigning and enforcing usage rights for a software application with one or more users by decoupling the identity of the person who purchases the application from the actual users of the application. Additionally, the systems and methods provide for centralized built-in user assignment with support for multiple applications.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

The same number represents the same element or same type of element in all drawings.

FIG. 1A illustrates an embodiment of a first portion of a flowchart representing a method 100 for assigning and/or enforcing usage rights for a software application.

FIG. 1B illustrates the embodiment of a second portion of the flowchart representing the method 100 for assigning and/or enforcing usage rights for the software application.

FIG. 2A illustrates an embodiment of a schematic of communication between various components for a system 200 for assigning and/or enforcing usage rights of a software application.

FIG. 2B illustrates an embodiment of a schematic of communication between various components for the system 200 for assigning and/or enforcing usage rights of the software application.

FIG. 2C illustrates an embodiment of a schematic of communication between various components for the system 200 for assigning and/or enforcing usage rights of the software application.

FIG. 3 illustrates an embodiment of a computer environment and computer system 300 for implementing the methods disclosed herein.

FIG. 4 illustrates an embodiment of various components a system 400 for assigning and/or enforcing usage rights of a software application for implementing the methods disclosed herein.

### DETAILED DESCRIPTION

This disclosure will now more fully describe exemplary embodiments with reference to the accompanying drawings, in which some of the possible embodiments are shown. Other aspects, however, may be embodied in many different forms and the inclusion of specific embodiments in the disclosure should not be construed as limiting such aspects to the embodiments set forth herein. Rather, the embodiments depicted in the drawings are included to provide a disclosure that is thorough and complete and which fully conveys the intended scope to those skilled in the art. When referring to the figures, like structures and elements shown throughout are indicated with like reference numerals.

The various embodiments described herein generally provide systems and methods for assigning and enforcing usage rights, such as a license, for software programs. Assignment and enforcement of usage rights for software applications is complex. For example, platforms that offer built-in license mechanisms often require software providers to either: 1) sell the application for a fixed price to an unlimited set of users; or 2) map users of the underlying platform to users of the application, which is also a costly endeavor as each application has to create its own subset of users that needs be managed individually (on each application, with its own interface and rules) by administrators. This is a major problem for volume-license (multi-users) purchase scenarios for mid-size and enterprise companies. Accordingly, many application providers rely on low technology/hard to manage systems (such as manual license key distribution), rely on honor-based systems without proper verification of usage rights, or do not participate on the application ecosystems (e.g. marketplaces).

In order to address this issue, embodiments of the present disclosure decouple the identity of the user that purchases the application from the actual users of the application. The client platform is integrated with licensing infrastructure provided by one or more licensing authorities to determine license rights (e.g. seats purchased). The seats purchased are assigned to actual application users using a standard, centralized set of client platform user interfaces and application programming interfaces (API). In some embodiments, the application during execution by a user further verifies the validity of the license information sending the license information upon request via API to a verification service provided by the licensing authority or marketplace infrastructure.

The decoupling of the purchaser identity from the identities of the actual user or users of the application provides the ability to assign unlimited users without seat assignments, to assign multiple users with seat assignments, and to use time-expiring licenses. Further, the client platform provides for centralized built-in user assignment with support for multiple applications. For example, the client platform may assign a first group of users of the client platform at the request of a first purchaser of a first application who is a registered user of the client platform and may assign a second group of users of the client platform to a second application based on the request of a second purchaser of a second application who is a registered user of the client platform. In this example, the first and second purchaser may be the same user of the client platform or may be different users of the client platform. Further, the first group of users and the second group of users may be different groups of users, may be the same group of users, or may include some of the same users and some different users of the client platform. Basically, the client platform allows a registered user of the client platform to purchase multiple applications and assign usage rights based on purchased seats to any other registered user (including all registered users and/or anonymous visitors) of the client platform while also allowing a different registered user to purchase multiple applications and assign usage rights based on purchased seats to any other registered user of the client platform.

Further, different purchased applications may utilize different licensing authorities and/or verification services to execute and enforce the licenses of these applications. For example, the client platform is an agnostic platform that assigns licenses for multiple applications, with each application having its own licensing authority and/or verification service. However, the purchaser and user will encounter a common experience through the use of the client platform regardless of what licensing authority and/or verification system is utilized by the purchased application.

The systems and methods as described herein work both on hosted and on-premises versions of a client platform. Further, the systems and methods as described herein allow the purchaser to assign one or more license managers. The license manager can administer the license, such as providing seat assignments. Additionally, the systems and methods as described herein allow for periodic and/or automatic renewal of licenses, which prevents casual piracy, prevents abuse of licenses, and enables cancellation of licenses for fraud or refund scenarios. The systems and methods as described herein also allow a particular license to be tied to a given deployment and/or system.

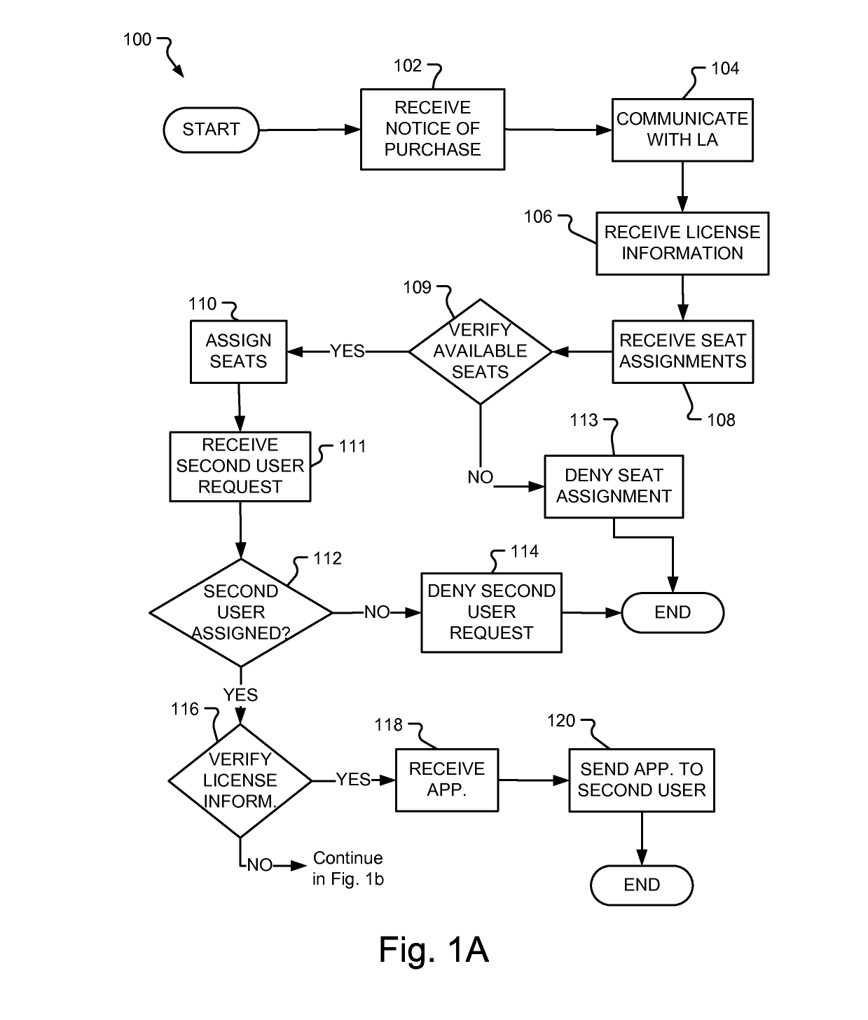

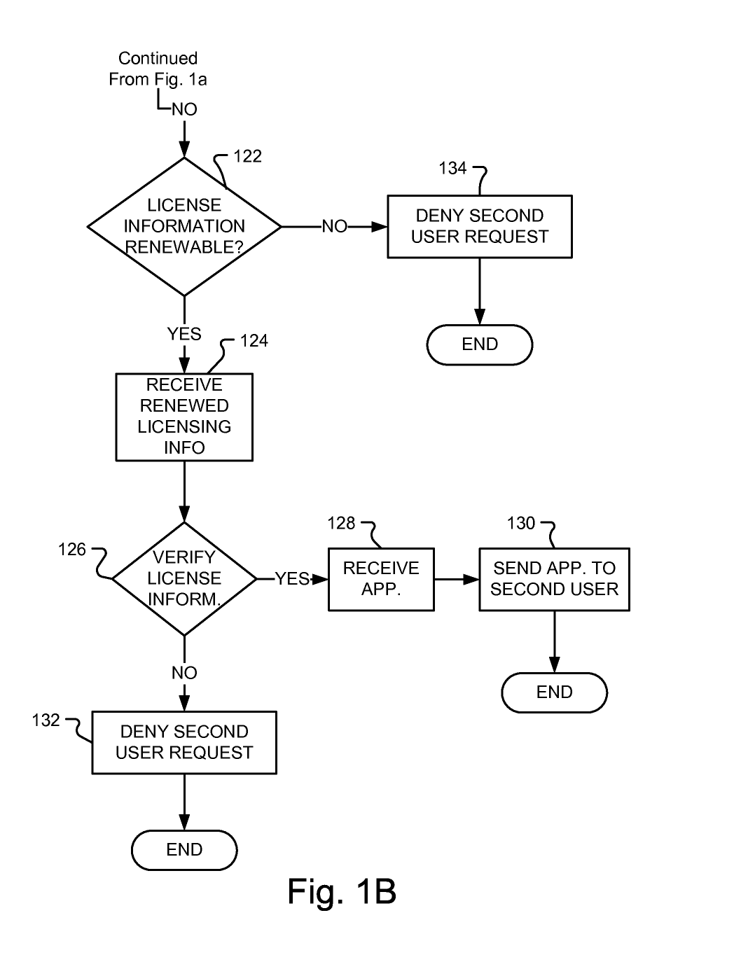

FIGS. 1A and 1B illustrate an embodiment of a flowchart representing a method 100 for enforcing and/or assigning usage rights for a software application. Flow begins at operation 102 in which notice of a purchase of an application from a purchaser is received by the client platform performing the method 100. In this embodiment, the purchaser requests to purchase the application through the client platform. The purchaser is as any person or device purchasing the licenses, a device controlled by the person who purchases the licenses, or a device to which the person purchasing the licenses has authenticated himself/herself. The purchaser may include an interface, such as an API, used to communicate with the client platform and other software and/or hardware as discussed herein. In some embodiments, the purchaser is a website administrator and the purchased application is run or executed on the website administrator's website.

Further, the purchaser is a registered user of the client platform. The user of the client platform is any person or device registered to use the client platform, a device controlled by the person who is registered to use the client platform, or a device to which the person who registered to use the client platform has authenticated himself/herself. Accordingly, the user may include an interface, such as an API, used to communicate with the client platform and other software and/or hardware as discussed herein.

In some embodiments, the client platform is the SHAREPOINT® software product available from Microsoft Corporation of Redmond, Wash. as executed on suitable hardware. The client platform may be an on-line version or an on-premises version of the client platform. In some embodiments, the received notice includes the number of seats purchased by the purchaser for the application. In some embodiments, an unlimited number of seats are purchased by the purchaser. In further embodiments, the received notice includes a time-limit on the usage rights.

Flow proceeds to operation 104 from operation 102. At operation 104, information regarding the software system utilized by the purchaser is sent to the licensing authority (illustrated as “LA”). In some embodiments, the licensing authority is or is within MICROSOFT® Office or Office.com (also known as OMEX). In other embodiments, the licensing authority is or is within MICROSOFT® Office Marketplace. In embodiments, the client platform sends a deploymentID of the client platform (e.g., a deploymentID of the tenancy of SHAREPOINT®) to the licensing authority. In some embodiments, the client platform looks up this information from an existing database, rather than needing to send the information every time.

In embodiments, the application purchase is limited to only a certain number of deployments. For example, in some embodiments, the installation of the application is allowed on only one deployment by having a unique identifier for the deployment (e.g. deploymentID). In another example, application installment may be restricted by hardware signatures of the servers. In another example, installation of the application may be limited to a fixed number of deployments/servers. In a further example, the installation of the application may be restricted by an internet protocol address of the enterprise.

The sent information may also include a timestamp of the purchase of the application, the number of seats requested to be purchased by the purchaser, and/or an identification of the purchaser. Accordingly, in this embodiment, the licensing authority processes the received information and completes the purchase of the application. When the purchase is complete, the licensing authority records the transaction. In some embodiments, the licensing authority records the system/deployment identification information received from the client platform. In some embodiments, the licensing authority records the transaction by recording a deploymentID of the client platform, the identification of the purchaser (e.g., WINDOWS LIVE ID), the timestamp of the transaction, and/or the number of users or seats purchased by the purchaser.

In other embodiments, not shown, the application is not purchased through the client platform. In these embodiments, the client platform receives notice of the purchase of an application from information sent by the purchaser from the third party storefront. In alternative embodiments, the third party storefront sends the purchase information to the client platform, which the client platform links to the purchaser after the purchaser logs into the client platform.

Flow proceeds to operation 106 from operation 104. At operation 106, license information for the purchased application is received from the licensing authority. The license information may include a clear text version of the license and an accompanying digital signature. The ability to digitally sign a license helps to prevent piracy. Further, in some embodiments, the license is a time limited license. In some embodiments, the license may require periodic renewal, automatic renewal, and/or expires after a predetermined amount of time. In other embodiments, the license may grant different levels of access to the application, such as a trial version, basic version, and/or premium version of the application. These different levels may be associated with different data storage and/or access to different features within a given application. Accordingly, the received license information may expire after a predetermined amount of time, determine what portions of the application the user can access, and/or require periodic or automatic renewal.

Flow proceeds to operation 108 from operation 106. At operation 108, seat assignment requests from a license director are received for other users of the client platform. The license director is provided with rights to manage the license of the application. In embodiments, the license director specifically requests the client platform assign one or more users of the client platform seats to the application. In other embodiments, the seats are assigned to users automatically by the application provider, licensing authority, and/or client platform. In some embodiments, seats are only assigned to users of the client platform. In other embodiments, the license director may request that the client platform assign large groups of registered users seats to a purchased application, such as all or a portion of users of the client platform.

In embodiments, the purchaser is a license director of the application. In some embodiments, the purchaser and/or the license director is also a website administrator. Further, in some embodiments, the website administered by the website administrator is administrated, run, and/or executed through a client platform, such as SHAREPOINT®. In embodiments, the seat assignments are received from the purchaser. Further, in embodiments, any administrator of the client platform may also be declared a license director. In some embodiments, the seat assignments are received from an administrator of the client platform. The license director may assign a seat to the application to one or more registered users of the client platform. Further, the license director may remove an assigned seat from one or more registered users of the client platform. In other embodiments, the license director assigns one or more users of the client platform as a license manager. In some embodiments, the license director may assign all registered user as license managers. Further, the license director may remove the assignment of a license manager from one or more users of the client platform.

An assigned license manager has the power to assign one or more seats of the application to one or more registered users of the client platform and the power to remove seats from one or more registered users of the client platform for the application. Accordingly, in some embodiments, the license manager may add or remove a seat assignment to the application to himself or herself. Accordingly, in some embodiments, the license director and/or the license manager can assign seats to one or more users of the client platform for the application and remove assigned seats from one or more users of the application. However, the license manager, unlike the license director, may not assign other users as license managers or request that the assignment of a license manager to another user be removed. The license director may assign seats and/or license managers for the application at the same time as the application is purchased or at a later time.

Next, flow proceeds to operation 109 from operation 108. At operation 109, a determination is made as to whether any seats are available for assignment. In embodiments, the client platform determines if there are seats available by comparing the number of seats purchased for the application to the number of seats that have already been assigned. If the client platform determines that all of the purchased seats have been assigned, the assignment is not allowable and flow branches “NO” to operation 113. At operation 113, the requested seat assignments are denied. In embodiments, the client platform denies the requested seat assignments. In some embodiments, the client platform may receive two or more seat assignment requests and only a portion of which are available for assignment. In embodiments, the client platform proceeds to operation 110 and automatically allows the first received requests until there are no more remaining seat assignments. Once the client platform determines that there are no more remaining seats available for assignment, the assignment is not allowable and flow branches “NO” to operation 113 for the remaining unprocessed seat assignment requests.

In some embodiments, the requested seat assignments are denied without any explanation during operation 113. In other embodiments, the requested seat assignments are denied and the purchaser is notified that there are no more seats available for assignment during operation 113. In further embodiments, a request is sent to the purchaser to determine if the purchaser desires to purchase more seat assignments for the application during operation 113.

In embodiments, the application may require certain permissions to run that some users may not have. For example, in a client platform deployment with a 1000 sites, one specific user may purchase a cool ‘archived project search’, but to work, the application needs to show data from every other site. In other embodiments, the list of users who could be assigned rights is shrunk to match just those users with sufficient permissions/privileges necessary to run a purchased application.

If a determination is made that not all of the purchased seats for the application have been assigned, the assignment is allowable and flow branches “YES” to operation 110. In embodiments, the client platform determines that the seat assignment is allowable. At operation 110, seats are assigned to the selected registered users of the client platform based on the received request. In embodiments, the client platform performs the seat assignments. In some embodiments, the client platform stores the received seat assignments.

Flow proceeds to operation 111 from operation 110. At operation 111, a request is received from a second user of the client platform to use the purchased application. In embodiments, the request is received by the client platform. The second user does not need to have the credentials of the purchaser to use the purchased application. However, in embodiments, the second user of the client platform must be assigned a seat to the application and the client platform must have valid license information in order for the second user to receive authorization to use the requested application. In other embodiments, where an unlimited number of uses are purchased, there is no need to explicitly assign a seat to a second user of the client platform, since all users on the deployment will have been assigned a seat to the application.

Accordingly, flow proceeds to operation 112 from operation 111. At operation 112, a determination is made if the second registered user has been assigned a seat to the application from the assigned seats during operation 110. In embodiments, the determination is made by the client platform. If the second registered user does not have an assigned seat, flow branches “No” to operation 114. At operation 114, the second user's request to use the purchased application is denied. In embodiments, the client platform denies the request. In some embodiments, the second user is notified that the request has been denied since the second user is not an assigned user of the application. In other embodiments, the purchaser is notified of the second user's failed request to receive the application, and the notification may include an inquiry whether the purchaser wants to assign a seat to the second user. In other embodiments, the second user request to receive the application is denied without an explanation to the purchaser and/or second user as to why the request was denied.

Returning to operation 112, if a determination is made that the second registered user has an assigned seat based on the assigned seats from operation 110, flow branches “Yes” to operation 116. At operation 116, authorization to use the application is requested. In embodiments, the client platform requests authority to use the purchased application by sending the received license information to the licensing authority.

If the licensing authority determines that the clear text version and accompanying digital signature of the license is valid, flow branches “Yes” to operation 118. At operation 118, authorization to use the requested purchased application is received from the licensing authority based on the received clear text version and accompanying digital signature of the license. The client platform may receive the authorization and in some embodiments store the authorization to use the purchased application.

Next, flow proceeds to operation 120 from operation 118. At operation 120, the second user (or a user with an assigned seat to the purchased application) is sent the authorization to use the purchased application. In embodiments, this may include sending to the second user the executable instructions necessary to run the application. In some embodiments, the client platform sends the authorization to the second user. The second registered user can then execute or use the purchased application. Accordingly, the application may enforce the license, the client platform may enforce the license, or the application in combination with the application may enforce the license. For example, in embodiments, the client platform may simply alert a user who is not being allowed to use the application, while the application enforces that the user cannot fully use the application. In an alternative example, an application could be executed without a license if the application does not check for a valid license.

Returning to operation 116, if the license is not valid, flow branches “No” to operation 122, as illustrated in FIG. 1B. As discussed above, the licensing information may require automatic renewal, periodic renewal, and/or may expire after a predetermined amount of time. Further, licenses may be revoked after a product is returned or after a fraud is discovered. At operation 122, a determination is made if the invalid licensing information is renewable. The client platform may determine if a license is renewable by periodically communicating with the licensing authority. If notice from the licensing authority is received that a license has been renewed or updated, flow branches to “Yes” to operation 124. In embodiments, notice is received by a client platform. The licensing authority sends the renewed license information to the client platform. At operation 124 the renewed licensing information is received from the licensing authority. The renewed license information may be received in a clear text version and accompanying digital signature by the client platform.

Returning to operation 122, if notice from the licensing authority is received that the license has not been renewed, flow branches “No” to operation 134. Again, the client platform may determine if a license is renewable by periodically communicating with the licensing authority. A licensing authority may revoke or terminate a license due to fraud or cancellation.

Alternately, in some embodiments, the licensing authority may give a grace period (a.k.a. a dunning cycle) where the licensing authority alerts the purchaser to verify the license. For example, if a monthly subscription was purchased by the purchaser, which is being charged by a credit card that fails one month, the licensing authority may give a grace period to the purchaser to enter a different payment method before the licensing authority actually terminates the license.

Further, if a time period has expired on a time limited license, the license may also be expired. In these instances, the licensing authority does not send a renewed license to the client platform. Accordingly, at operation 134, the second user's request to use the application is denied. In embodiments, the client platform denies the request. In some embodiments, the second registered user is notified that the request has been denied because the license is no longer valid during operation 134. In other embodiments, the purchaser is notified of the license termination during operation 134. In some embodiments, a request is sent to the purchaser to determine if the purchaser wants repurchase the application and/or renew the expired license during operation 134. In some embodiments, prior to the license expiring, a user and/or purchaser is warned of an upcoming license termination or expiration. In other embodiments, the second registered user's request to use the application is denied without an explanation as why the request was denied during operation 134.

Flow proceeds to operation 126 from operation 124. At operation 126, similarly to operation 116, authorization to use the purchased application utilizing the received renewed clear text version and accompanying digital signature of the license is requested. Accordingly, the client platform may send the received renewed clear text version and accompanying digital signature of the license to the licensing authority to verify that the received renewed clear text version and accompanying digital signature of the license is still valid.

In some embodiments, the license is validated by utilizing a single private key on the licensing authority side to sign a license. To verify license state, either the application or the client platform has to communicate with the licensing authority to determine if the license is valid. In some embodiments, the license is validated by utilizing asymmetric keys, where a strong private key and a certificate authority are used to sign a license, and the client platform and/or application use a public key to verify the integrity of the license without communication with the licensing authority.

If the licensing authority determines that the renewed license is not valid, flow branches “No” to operation 132. At operation 132, notice that the license is not valid is sent from the licensing authority by denying the request to receive authorization to use the application and the second registered user's request to use the application is denied. In embodiments, the client platform denies the second user's request. In some embodiments, operation 132 is similar to operation 134 discussed above. As discussed above, in some embodiments, the second registered user is notified that the request has been denied because the license is no longer valid during operation 132. In other embodiments, the purchaser of the license termination is notified of the denial during operation 132. In some embodiments, a request is sent to the purchaser to determine if the purchaser wants repurchase the application and/or renew the expired license during operation 132. In other embodiments, the second registered user's request to use the application is denied without an explanation as to why the request was denied during operation 132.

In alternative embodiments, the client platform denies the request by the user to receive full authorization to use the purchased application and instead sends the user authorization to use the purchased application with a reduced functionality. For example, the authorization with reduced functionality may only allow the application to function in a read-only mode, to access specific features, and/or have reduced data speed.

Returning to operation 126, if the licensing authority determines that the renewed license is valid, the licensing authority sends the authorization to use the purchased application and flow branches “Yes” to operation 128. At operation 128, authorization to use the requested purchased application is received from the licensing authority based on the received clear text version and accompanying digital signature of the license. The client platform may receive the authorization to use the purchased application and/or store the received authorization to use the purchased application.

Next, flow proceeds to operation 130 from operation 128. At operation 130, authorization to use the purchased application is sent to the second registered user. In embodiments, this may include sending to the second user the executable instructions necessary to run the application. In some embodiments, the client platform sends the authorization to the second registered user. In some embodiments, the second registered user can then execute or use the purchased application once the second registered user receives the authorization.

In an additional embodiment, when a user tries to execute or use the received application, the application calls a verification service prior to allowing the user to use the purchased application. Accordingly, in these embodiments, the client platform sends the license information to the verification service. Further, the client platform sends any assigned seats and/or assigned license managers to the verification service. The verification service is provided by the licensing authority. The verification service communicates with the licensing authority to verify the license information received from the client platform. If the license is valid, the verification service sends notice back to the client platform that the license information is valid and the client platform allows the user to use the purchased application. If the license is invalid, the verification service sends notice back to the client platform that the license information is invalid and the client platform prevents the user from using the purchased application.

In embodiments, method 100 is deigned to be performed by the client platform for the purchase of multiple applications by the same purchaser or the purchase of one or more applications by multiple different purchasers. The client platform may perform method 100 simultaneously and/or concurrently for different purchasers of one or more applications.

Further, different purchased applications may utilize different licensing authorities and/or verification services during method 100. The purchaser and the user will have the same experience in purchasing the application and/or in receiving authorization to use the purchased application regardless of which licensing authorities and/or verification services are utilized by the purchased application by utilizing the client platform to enforce and assign usage rights.

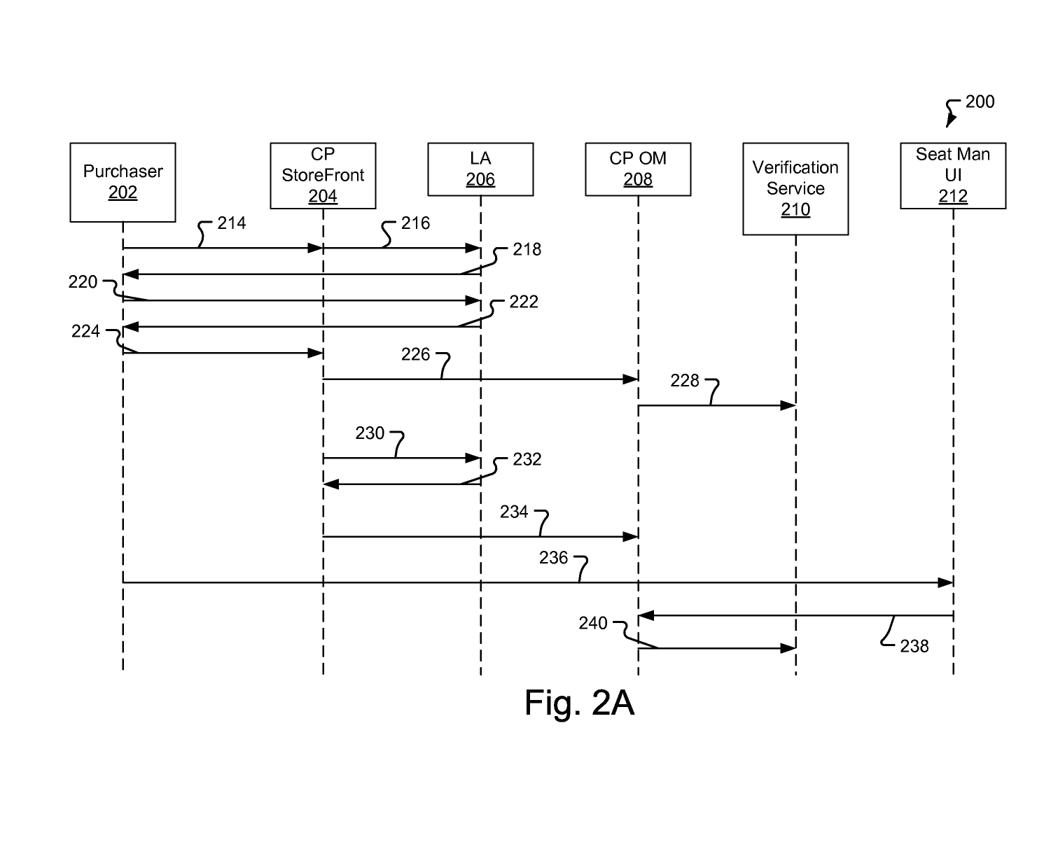

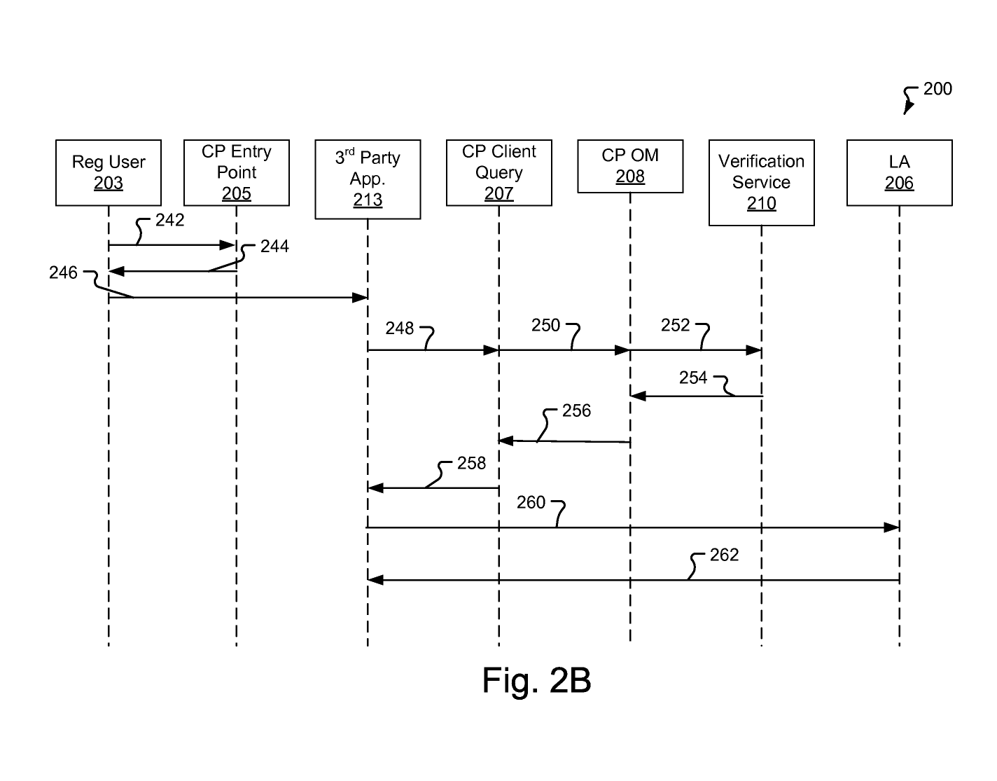

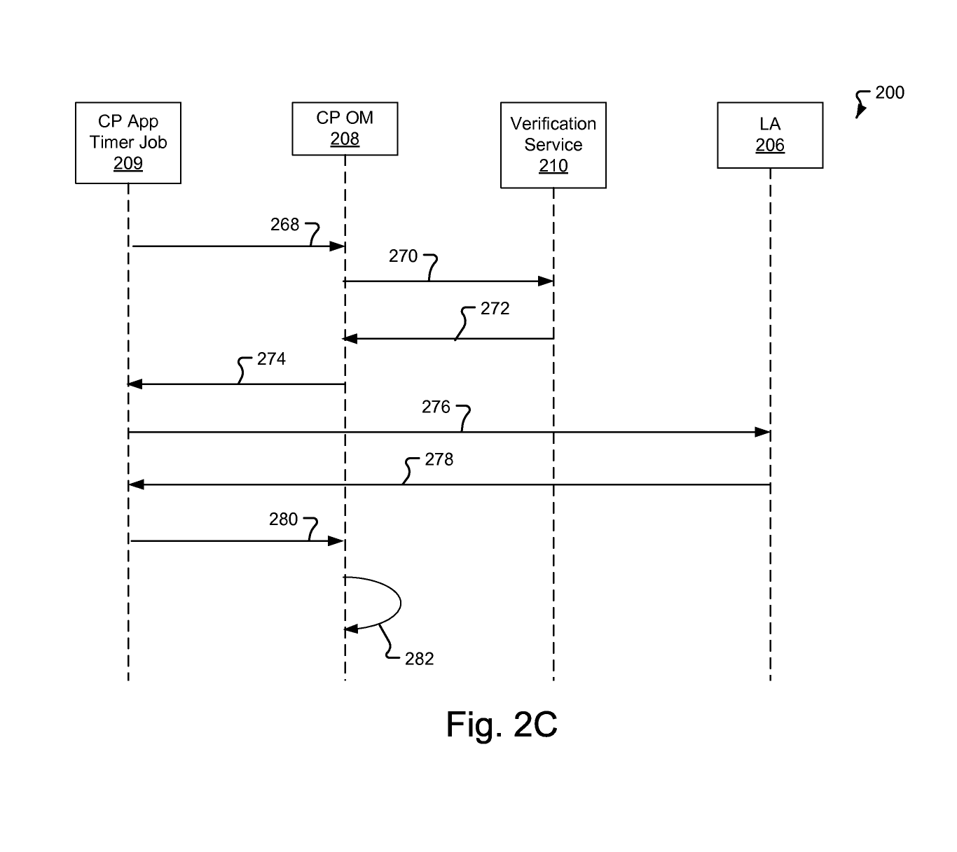

FIGS. 2A, 2B, and 2C illustrate an embodiment of a schematic of communication between various components of a system 200 for assigning and/or enforcing usage rights of a software application. As illustrated in the embodiment of FIG. 2A, a purchaser 202 communicates with a client platform. The purchaser may be a registered user of the client platform. The client platform includes a client platform storefront 204 (illustrated as “CP StoreFront”), a client platform entry point 205 (illustrated as “CP Entry Point”), a client platform client query 207 (illustrated as “CP Client Query”), a client platform application timer job 209 (illustrated as “CP App Timer Job”), and a client platform object model 208 (illustrated as CP OM). In some embodiments, the client platform may comprise the SHAREPOINT® software product available from Microsoft Corporation of Redmond, Wash. as executed on suitable hardware. The client platform recognizes the purchaser 202 as a registered user of the client platform. The purchaser 202 sends a request to purchase an application during communication 214 to the client platform storefront 204. In some embodiments, the client platform storefront 204 is a SHAREPOINT® StoreFront. However, as known by a person of skill in the art, any suitable client platform may be utilized in place of SHAREPOINT® for the current embodiment. In some embodiments, the purchaser is a website administrator and is purchasing the application to run on the administrator's website. In embodiments, the website may be run, administrated, and/or executed through the client platform, such as SHAREPOINT®.

The client platform storefront 204 communicates with a licensing authority 206 during communication 216. In some embodiments, the licensing authority 206 is OMEX. As known by a person of skill in the art, any suitable licensing authority may be utilized in the illustrated embodiment. During communication 216, the client platform storefront 204 sends information that at least identifies the software system of the purchaser or first user 202 to the licensing authority 206 along with application purchase request. The information that identifies the software system of the purchaser 202 may include a deploymentID and/or client identification, such as a WINDOWS LIVE ID. The client platform storefront 204 may send other information to the licensing authority 206, such as the timestamp of the application purchase and/or the number of seats requested for purchase by the purchaser 202 for the application. The licensing authority 206 processes the payment information of the purchaser 202 and completes the requested purchase of the application.

After communication 216, the licensing authority 206 sends the completion of the purchase to the purchaser 202 along with a login to the licensing authority 206 and requests that the purchaser 202 login to the licensing authority 206 during communication 218. In response to the request in communication 218, the purchaser 202 logs into the licensing authority 206 during communication 220. In response to communication 220, the licensing authority 206 sends the licensing information for the purchased application to the purchaser 202 during communication 222.

The licensing information received by the purchaser 202 is automatically redirected to the client platform storefront 204 during communication 224. In some embodiments, the licensing authority 206 sends the licensing information directly to the client platform storefront 204. In embodiments, the license information includes a clear text version and accompanying digital signature of the license. In some embodiments, the license information may tie the given license to a specific system and/or deploymentID. Further, the license may be a time limited license that expires after a predetermined amount of time. In other embodiments, the license may require automatic and/or periodic renewal to prevent piracy of the application. The client platform storefront 204 sends the licensing information to a client platform object model 208 (illustrated as “CP OM”) for storage during communication 226.

In some embodiments, the license information of the purchased application can be further verified by communicating with a verification service 210. In embodiments, the verification service 210 is provided by the licensing authority 206. For example, the verification service 210 in some embodiments is an Application Management Shared Service. As illustrated in the embodiment shown in FIG. 2A, the client platform object model 208 sends the received license information to the verification service 210 during communication 228.

As discussed later on, in some embodiments, when the application is executed by the purchaser 202, the application calls a verification service to verify the integrity of the license. If the verification service verifies the integrity of the license information received from the client platform, then the verification service sends notice to the client platform to allow the purchaser 202 or an assigned user 203 to use the application. If the verification service determines that the license information from the client platform is not valid, then the verification service sends notice to the client platform, which prevents the purchaser 202 or assigned user 203 from being able use the application.

Use of the application according to the present embodiments will now be discussed. Once the client platform storefront 204 receives the license information, the client platform storefront 204 at any time can send the license information (i.e. the clear text version and accompanying digital signature of the license) to the licensing authority 206 to request authorization to use the purchased application during communication 230. For example, while not shown in FIG. 2A, a user of the client platform may request use of the purchased application. The client platform storefront 204 may send the license information to the licensing authority 206 to request authorization via communication 230 to use the purchased application. If the licensing authority 206 determines that the license information sent by the client platform storefront 204 is valid, the licensing authority 206 sends authorization to use the application to the client platform storefront 204 during communication 232. The client platform storefront 204 sends the authorization to use the purchased application to client platform object model 208 for storing the application during communication 234. While not illustrated in FIGS. 2A, 2B, and 2C, once the client platform storefront 204 receives the authorization to use the purchased application, the client platform storefront 204 can send the authorization to use the application to an assigned user of the client platform.

Assignment of client platform users to seat licenses will now be discussed. Any time after the purchase of the application, during communication 236, the purchaser 202 sends to the seat management user interface 212 (illustrated as “Seat Man. UI”) a request to assign specific users of the client platform seats to the purchased application. In other embodiments, not shown, the purchaser 202 can send requested seat assignments to the client platform storefront 204. If the seats are available, Seat Management User Interface 212 or the client platform storefront 204 assigns and records the requested seat assignments. As illustrated in this embodiment, the seat management user interface 212 sends the assigned seats to the client platform object model 208 for storage during communication 238. As illustrated, in embodiments with a verification service 210, the client platform object model 208 sends the assigned seats to the verification service 210 during communication 240. The verification service 210 may also store the assigned seats.

In other embodiments, the purchaser 202 may also send a request to assign another registered user of the client platform as a license manager to the application during communication 236 to seat management user interface 212. In embodiments with a license manager, the purchaser 202 may choose not to assign any seats to the application and instead allow the one or more license managers to assign all or a portion of the purchased seats to the application to registered users of the client platform. Accordingly, the seat management user interface 212 sends the assigned license manager to the client platform object model 208 for storage during communication 238. Further, in embodiments with a verification service 210, the client platform object model 208 sends the assigned license manager to the verification service 210 during communication 240. Accordingly, the client platform object model 208 assigns the specified registered user of the client platform as a license manager. The verification service 210 may further store the assigned license manager.

As illustrated in the embodiment shown in FIG. 2B, a recognized registered user 203 (illustrated as “Reg. User”) of the client platform requests to load the client platform entry page from the client platform entry point 205 during communication 242. The client platform entry page contains application entry points or locations where a recognized registered user 203 can request use of the purchased application. The client platform entry point 205 sends the client platform entry page to the registered user 203 during communication 244.

The recognized registered user 203 requests to use a purchased application from a third party application provider interface 213 (illustrated as “3^{rd} Party App.”) during communication 246. In some embodiments, the application is developed and/or sold by the client platform. The recognized registered user 203 makes this request through the client platform entry page. The third party application provider interface 213 requests license information from the client platform client query 207, which is part of the client platform, during communication 248. The client platform client query 207 allows clients to access data on a server. Accordingly, the client platform client query 207 requests the license information from the client platform object model 208 during communication 250, which the client platform object model 208 received during communication 226 as illustrated in FIG. 2A.

In embodiments with a verification service 210 as illustrated in FIGS. 2A, 2B, and 2C, the client platform object manager requests the license information from the verification service 210 during communication 252, which the verification service 210 received during communication 228 as illustrated in FIG. 2A. In these embodiments, the verification service 210 sends the license information to the client platform object model 208 during communication 254.

The client platform object model 208 sends the license information to the third party application provider during communication 258. The license information includes the clear text version and an accompanying digital signature of the license for the application. The third party application provider interface 213 verifies the received license information by sending the license information to the licensing authority 206 during communication 260.

The licensing authority 206 does not know the identity of any registered user 203 of the client platform. Accordingly, the licensing authority 206 will only authenticate licensing information, provide authorization to use an application, and/or send out the license information for a purchased application if one of the following two things are received by the licensing authority 206: 1) the username and password of the purchaser 202 is received by the licensing authority 206; and/or 2) the license information or license token is received by the licensing authority 206. The license information prevents a user 203 from having to be the same person as the purchaser 202 and/or from having to know the purchaser's username and password.

The licensing authority 206 confirms that the received license information is valid based on the clear text version and accompanying digital signature of the license received during communication 260. A license may be invalid due to a time limitation, fraud detection, and cancellation and/or refund to the purchaser 202 for a returned application. The licensing authority 206 sends notification to the third party application provider interface 213 as to whether the license information is valid or invalid during communication 262. In some embodiments, the third party application provider interface 213, allows access or use to the purchased application if the license information is valid. Alternatively, in other embodiments, the third party application provider interface 213, will deny access or use to the purchased application if the license information is invalid.

Renewal of license information by the client platform will now be discussed. As illustrated in the embodiment shown in FIG. 2C, a client platform timer job 209 may periodically check to determine if any of the received license information has become invalid. In some embodiments, the client platform timer job 209 is a routine running on the client platform. Accordingly, in one of these periodic intervals, the client platform timer job 209 requests that the client platform object model 208 send any invalid license information to the client platform timer job 209 during communication 268. In embodiments, with a verification service 210, the client platform object model 208 further requests any invalid license information from the verification service 210 during communication 270. The verification service 210 sends any invalid or potentially invalid license information to the client platform object model 208 during communication 272. The client platform object model 208 sends any stored invalid or potentially invalid license information to the client platform timer job 209 during communication 274. Again, FIG. 2C illustrates just one embodiment of how licenses may be renewed and/or updated.

The client platform timer job 209 request renewal or updating of any invalid or potentially invalid license information from the licensing authority 206 during communication 276. If the invalid or potentially invalid license or licenses have been renewed or updated, the licensing authority 206 sends renewed or updated license information to the client platform timer job 209 during communication 278. In embodiments, the renewed license information includes a clear text version and accompanying digital signature of the renewed license information.

The client platform timer job 209 sends the renewed license information to the client platform object model 208 for storage during communication 280. Further, in some embodiments, the client platform object model 208 may further check that the stored assigned seats are still less than the total seats purchased by the purchaser 202 during communication 280 based on the renewed license information received during communication 280 and the stored seat assignments received during communication 238.

System 200 is configured to provide assignment and enforcement of usage rights to one or more assigned client platform users by one purchaser of one or more applications. Further, system 200 is configured to provide assignment and enforcement of usage rights to one or more assigned client platform users by multiple different purchasers of one or more applications. Additionally, different purchased applications may utilize different licensing authorities 206 and/or verification services 210 in system 200. The purchaser 202 and the user 203 will have the same experience in purchasing the application and/or in receiving authorization to use the purchased application regardless of which licensing authorities 206 and/or verification services 210 are utilized by the purchased application by utilizing a client platform to enforce and assign usage rights.

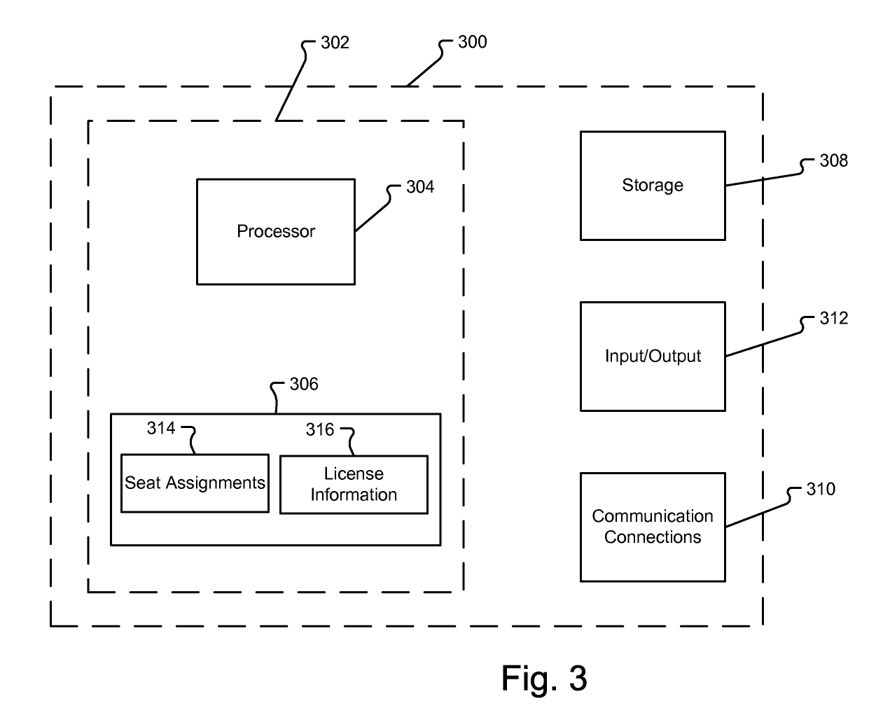

With reference to FIG. 3, an embodiment of a computing environment for implementing the various embodiments described herein includes a computer system, such as computer system 300. Any and all components of the described embodiments may execute as or on a client computer system, a server computer system, a combination of client and server computer systems, a handheld device, and other possible computing environments or systems described herein. As such, a basic computer system applicable to all these environments is described hereinafter.

In its most basic configuration, computer system 300 comprises at least one processing unit or processor 304 and system memory 306. The most basic configuration of the computer system 300 is illustrated in FIG. 3 by dashed line 302. In some embodiments, one or more components of the described system are loaded into system memory 306 and executed by the processing unit 304 from system memory 306. Depending on the exact configuration and type of computer system 300, system memory 306 may be volatile (such as RAM), non-volatile (such as ROM, flash memory, etc.), or some combination of the two.

Additionally, computer system 300 may also have additional features/functionality. For example, computer system 300 includes additional storage media 308, such as removable and/or non-removable storage, including, but not limited to, magnetic or optical disks or tape. In some embodiments, software or executable code and any data used for the described system is permanently stored in storage media 308. Storage media 308 includes volatile and non-volatile, removable and non-removable media implemented in any method or technology for storage of information such as computer readable instructions, data structures, program modules, or other data. In embodiments, the disclosed template and derived tables are stored in storage media 308.

System memory 306 and storage media 308 are examples of computer storage media. Computer storage media includes, but is not limited to, RAM, ROM, EEPROM, flash memory or other memory technology, CD-ROM, digital versatile disks (“DVD”) or other optical storage, magnetic cassettes, magnetic tape, magnetic disk storage, other magnetic storage devices, or any other medium which is used to store the desired information and which is accessed by computer system 300 and processor 304. Any such computer storage media may be part of computer system 300. In embodiments, system memory 306 and/or storage media 308 stores data used to perform the methods and/or form the system(s) disclosed herein, such as, assigning and enforcing usage rights for a software application. In embodiments, system memory 306 stores information such as seat assignments 314 and/or license information 316 for performing a method of assigning and enforcing usage rights for a software application as discussed with respect to FIGS. 1A, 1B, 2A, 2B, and 2C.

Computer system 300 may also contain communications connection(s) 310 that allow the device to communicate with other devices. In embodiments, communications connection(s) 310 may be used to transmit and receive messages between sender devices, intermediary devices, and recipient devices. Communication connection(s) 310 is an example of communication media. Communication media may embody a modulated data signal, such as a carrier wave or other transport mechanism and includes any information delivery media, which may embody computer readable instructions, data structures, program modules, or other data in a modulated data signal. The term “modulated data signal” means a signal that has one or more of its characteristics set or changed in such a manner as to encode information or a message in the data signal. By way of example, and not limitation, communication media includes wired media such as a wired network or direct-wired connection, and wireless media such as an acoustic, RF, infrared, and other wireless media.

In some embodiments, computer system 300 also includes input and output connections 312, and interfaces and peripheral devices, such as a graphical user interface. Input device(s) are also referred to as user interface selection devices and include, but are not limited to, a keyboard, a mouse, a pen, a voice input device, a touch input device, camera, recording device, etc. In embodiments with a camera, the camera may be operative to record a user and capture motions and/or gestures made by a user. In embodiments with a recording device, the recording device may be further operative to capture words spoken by a user, such as by a microphone, and/or capture other inputs from a user such as by a keyboard and/or mouse (not pictured). In some embodiments, a camera may comprise any motion detection device capable of detecting the movement of user. For example, the camera may comprise a Microsoft® Kinect® motion capture device comprising a plurality of cameras and a plurality of microphones.

Output device(s) are also referred to as displays and include, but are not limited to, cathode ray tube displays, plasma screen displays, liquid crystal screen displays, speakers, printers, etc. These devices, either individually or in combination, connected to input and output connections 312 are used to display the information as described herein. All these devices are well known in the art and need not be discussed at length here.

In some embodiments, the component described herein comprise such modules or instructions executable by computer system 300 that may be stored on computer storage medium and other tangible mediums and transmitted in communication media. Computer storage media includes volatile and non-volatile, removable and non-removable media implemented in any method or technology for storage of information such as computer readable instructions, data structures, program modules, or other data. Combinations of any of the above should also be included within the scope of readable media. In some embodiments, computer system 300 is part of a network that stores data in remote storage media for use by the computer system 300.

In further embodiments, the component described herein may be practiced via a system-on-a-chip (SOC) where each or many of the components illustrated in FIG. 3 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to providing continuous access to a resource, may operate via application-specific logic integrated with other components of the computer system 300 on the single integrated circuit (chip).

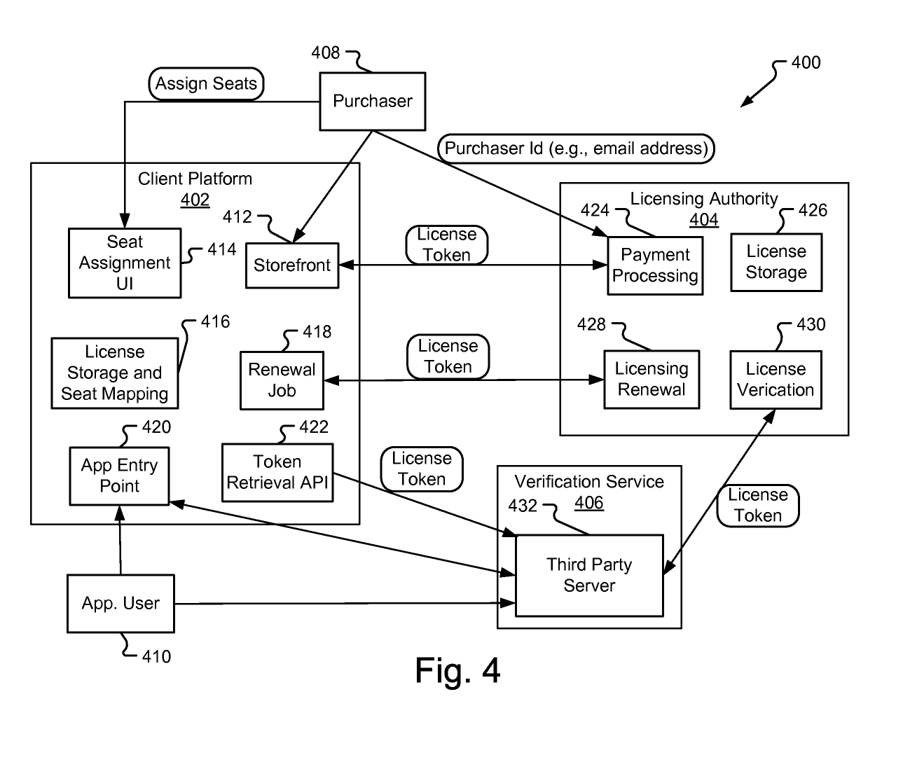

With reference to FIG. 4, an embodiment of various components a system 400 for assigning and/or enforcing usage rights of a software application is illustrated. Any and all components of the described embodiments may execute as or on a client computer system, a server computer system, a combination of client and server computer systems, a handheld device, and other possible computing environments or systems described herein. As such, a basic computer system applicable to all these environments is described above.

The system 400 as illustrated in FIG. 4 includes a client platform 402, a licensing authority 404, and a verification service 406. These networks or systems work together to allow a purchaser 408 of an application to assign seats to one or more users 410 of a client platform by decoupling the identity of the purchaser 408 from the purchased application and actual users 410 (illustrated as “App. User”) of the application. Further, the client platform 402 of system 400 allows a registered user of the client platform 402 to purchase multiple applications and assign usage rights based on purchased seats to any other registered user of the client platform 402 while also allowing a different registered user to purchase multiple applications and assign usage rights based on purchased seats to any other registered user of the client platform 402.

Different purchased applications may utilize different licensing authorities 404 and/or verification services 406. However, because a client platform 402 is utilized by the purchaser 408, the second user 410, and the purchased application to enforce and assign usage rights, the purchaser 408 and the second user 410 will have the same experience in purchasing the application and/or in receiving authorization to use the purchased application regardless of which licensing authorities 206 and/or verification services 210 are utilized by the purchased application.

As illustrated in FIG. 4, in some embodiments, the client platform 402 includes a storefront 412, a seat assignment user interface (illustrated as “Seat Assignment UI”) 414, a storage device (illustrated as “License Storage and Seat Mapping”) 416, a renewal job application 418, an application entry point service (illustrated as “App Entry Point”) 420, and a token retrieval API 422.

As illustrated in FIG. 4, in some embodiments, the licensing authority 404 includes a payment processing service 424, a storage device (illustrated as “License Storage”) 426, a licensing renewal application 428, and a licensing verification application 430. Further, as illustrated in FIG. 4, in some embodiments, the verification service 406 includes at least one third party server 432. In embodiments, the third party server 432 includes an application service code for enforcing licenses.

A purchaser 408, a registered user of the client platform 402, may request to purchase an application from the storefront 412 of the client platform 402. In some embodiments, the purchaser 408 is a website administrator and is purchasing an application to run on the website administered by the website administrator. In further embodiments, the website may be administered, executed, and/or run via the client platform 402.

The storefront 412 of the client platform 402 sends the purchase request and the identification of the software system of the purchaser 408 along with the requested seats for the application to the payment processing service 424 of the licensing authority 404. The purchaser 408 is directed to login to the payment processing service 424 of the licensing authority 404 by a communication sent from the client platform 402 and/or the licensing authority 404. The licensing authority 404 recognizes the purchaser's 408 login based on the identification of the software system of the purchaser received from the storefront 412. The purchaser 408 completes the purchase of the requested application with the payment processing service 424 by sending payment information to the licensing authority 404, which the payment processing service 424 processes.

After purchase of the application is complete, the payment processing service 424 receives the licensing information for the requested application from license storage 426 of the licensing authority 404. The license information may include a clear text version and accompanying digital signature of the license. As illustrated in FIG. 4 the license information may be referred to herein as a license token. The payment processing service 424 sends the license token to the storefront 412 of the client platform 402. In some embodiments, the licensing authority 404 may send the license token to the purchaser 408 who is then redirected to login in to the client platform 402. In this embodiment the client platform 402 receives the license token from the purchaser 408.

The license token is stored by the client platform 402 in the storage device 416. In some embodiments, where a verification service 406 is utilized, the token retrieval API 422 of the client platform 402 sends the received license token to one or more third party servers 432 of the verification service 406.

In some embodiments, the license information or license token received by the client platform 402 is a time limited license. In some embodiments, the license token received by the client platform 402 requires periodic renewal, automatic renewal, and/or expires after a predetermined amount of time. In other embodiments, the license token received by the client platform 402 grants different levels of access to the application, such as a trial version, basic version, and/or premium version of the application. These different levels may be associated with different data storage and/or access to different features within a given application. Accordingly, the received license information may expire after a predetermined amount of time, determine what portions of the application the user can access, and/or require periodic or automatic renewal.

Accordingly, the client platform 402 includes a renewal job application 418 that periodically communicates with the licensing renewal application 428 of the licensing authority 404. The renewal job application 418 sends expired and/or potentially expired licenses to the licensing renewal application 428. The licensing renewal application 428 determines if the expired and/or potentially expired licenses are expired and, if expired, if the expired licenses have been renewed. The licensing renewal application 428 may communicate with other applications in the licensing authority 404, such as the license storage 426 and the licensing verification application 430 to determine if the expired and/or potentially expired licenses have expired and/or have been renewed. If the licenses are still valid, the licensing renewal application 428 sends this information to the renewal job application 418. If the licenses have expired but have been renewed, the licensing renewal application 428 sends the new license token to the renewal job application 418. The client platform 402 stores the new license token in the storage device 416 of the client platform 402. If the licenses have expired and have not been renewed, the licensing renewal application 428 sends this information to the renewal job application 418. Accordingly, if a purchaser 408 or a second user 410 of the client platform tries to the access the application with the expired license, the client platform 402 will deny the request based on the expired license.

The purchaser 408 sends seat assignments for the purchased application to the seat assignment user interface 414 of the client platform 402. The purchaser 408 assigns seats to other registered users 410 of the client platform 402. The purchaser 408 may select individuals or groups of other registered users 410 of the client platform 402 for assignment. In some embodiments, the purchaser 408 purchases an unlimited number of seat assignments. In some embodiments, the purchaser 408 purchases a limited number of seat assignments. The purchaser 408 may send seat assignments to the client platform 402 any time after the purchase of the application.

The seat assignment user interface 414 or another component of the client platform 402 determines if the received seat assignments from the purchaser 408 are allowable (i.e., there are purchased seats available for assignment). The client platform 402 stored the number of seats purchased for the application in the storage device 416. If there are seats available for assignment, the seat assignment user interface 414 assigns the requested seat assignments to the selected or listed registered users of the client platform 402. If all of the purchases seats for the application have already been assigned, the seat assignment user interface 414 does not assign the requested seat assignments. In some embodiments, the client platform 402 may notify the purchaser 408 of the denial to assign the requested seats.

The client platform 402 saves the seat assignments received from the purchaser 408 in the storage device 416. In some embodiments, the seat assignments are further sent by the token retrieval API 422 to the third party server 432 of the verification service 406. In embodiments, the third party server 432 of the verification service 406 stores the received seat assignments.

A second registered user 410 of the client platform 402 may login to the client platform 402 and request authorization to use a purchased application from the application entry point service 420 on the client platform 402. The client platform 402 determines if the second user 410 has been assigned a seat to the application by the purchaser 408. If the client platform 402 determines that the second user 410 was assigned a seat to the application and the client platform 402 has a valid license to the application, the client platform 402 provides authorization to use the application to the second user 410. If the client platform 402 determines that the second user 410 was not assigned a seat to the application or that the license for the application is invalid, the client platform 402 denies the request of the second user 410 to use the application.

In some embodiments, where a verification service 406 is utilized, the client platform 402 may further verify that the license information is valid by communicating with the third party server 432 of the verification service 406. In these embodiments, the second user 410 is requested to login into the third party server 432 of the verification service 406. The verification service 406 determines if the second user 410 was assigned a seat to the application. The verification service 406 sends notice of whether the second user 410 was assigned a seat to the application entry point service 420 of the client platform. Further, the verification service 406 sends the received license token to the licensing verification application 430 of the licensing authority 404 to determine that the license is still valid.

If the licensing authority 404 determines that the license is still valid, the licensing verification application 430 sends verification of the valid license to the third party server 432 of the verification service 406. If the licensing authority 404 determines that the license is not still valid, the licensing verification application 430 sends notification of the invalid license to the third party server 432 of the verification service 406. The third party server 432 in response to the information received from the licensing authority 404 sends verification of the license or notice of the license invalidity to the application entry point service 420 on the client platform 402. Accordingly, the application entry point service 420 on the client platform 402 either provides the second user 410 with authorization to use the purchased application or denies the second user's request to use to use the application. For example, if the application entry point service 420 received notice from the verification service 406 that the second user 410 was assigned a seat to the application and the license token is still valid, the application entry point service 420 provides authorization to the second user 410 to use the application. In an alternative example, if the application entry point service 420 received notice from the verification service 406 that the second user 410 was not assigned a seat to the application and/or that the license token is not valid, the application entry point service 420 denies the request of the second user 410 to use the application.

In some embodiments, the purchaser may further assign other registered users 410 as license managers. The client platform 402 stores the license managers in the storage device 416. In some embodiments, if purchaser purchased a limited number of license managers, the client platform determines if seats are available for assignment. If seats are available for assignment, the client platform assigns the requested license managers. If the seats are not available, the client platform does not assign the requested license managers. In some embodiments, the client platform 402 may notify the purchaser 408 of the denied seat assignments. In some embodiments, when a verification service 406 is utilized, the client platform sends the assigned license managers to the third party server 432 of the verification service 406. In some embodiments the third party server 432 of the verification service 406 stores the received license managers.

In some embodiments, the application is run or executed on a mobile device utilizing the licensing authority and the client platform. For example, a user may be signed in with an identity known to the client platform on the user's mobile device. In another example, users on the client platform may be assigned seats to an application by entering phone identifications, such as hardware signatures.

This disclosure described some embodiments with reference to the accompanying drawings, in which only some of the possible embodiments were shown. For example, the use of a verification service is optional and may not be utilized by the systems and/or methods of the present disclosure. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art. In addition, terms like “first,” “second,” “third,” and “fourth” are used herein to distinguish between and among elements; however, no order of events or priority are intended unless otherwise indicated.

Although the embodiments have been described in language specific to structural features, methodological acts, and computer-readable media containing such acts, it is to be understood that the possible embodiments, as defined in the appended claims, are not necessarily limited to the specific structure, acts, or media described. One skilled in the art will recognize other embodiments or improvements that are within the scope and spirit of the present disclosure. Therefore, the specific structure, acts, or media are disclosed only as illustrative embodiments. The disclosure is defined by the appended claims.

What is claimed is:

1. A computer-implemented method of assigning and enforcing usage rights for a software application, the method comprising:
receiving at a client platform notice of an application purchase by a purchaser, wherein the purchaser is a first registered user of a client platform;
sending information to a licensing authority wherein the information identifies a software system utilized by the purchaser;
receiving a license for the purchased application from the licensing authority; and
receiving from a license director at least one seat assignment request to enable a second registered user of the client platform to use the purchased application, wherein the second registered user of the client platform is different from the purchaser;
verifying that the at least one seat assignment request is allowable for the purchased application; and
assigning at least one seat assignment to the second registered user based on the at least one seat assignment request.

2. The computer-implemented method of claim 1, wherein the information sent to the licensing authority includes at least one of a deploymentID of the client platform, an identification of the purchaser, a timestamp of the application purchase, and a number of seats purchased by the purchaser.

3. The computer-implemented method of claim 1, further comprising:
receiving from the license director at least one license manager assignment request for a third registered user, wherein the third registered user of the client platform is different from the purchaser and the second registered user; and
assigning at least one license manager assignment to the third registered user based on the at least one seat assignment request.

4. The computer-implemented method of claim 1, wherein the license director is the purchaser.

5. The computer-implemented method of claim 1, further comprising:
receiving from the license director a request to cancel a seat assignment for the second registered user of the client platform; and
removing the seat assignment for the second registered user based on the request from the license director.

6. The computer-implemented method of claim 1, further comprising:
receiving at the client platform notice of a second application purchase by a second purchaser, wherein the second purchaser is a third registered user of the client platform, and wherein the second purchaser is different from the first purchaser;
sending other information to the licensing authority, wherein the other information identifies a software system utilized by the second purchaser;
receiving a second license for the second purchased application from the licensing authority; and
receiving from a second license director a second at least one seat assignment request to enable a fourth registered user of the client platform to use the second purchased application, wherein the fourth registered user of the client platform is different from the second purchaser;
verifying that the second at least one seat assignment request is allowable for the second purchased application; and
assigning a second at least one seat assignment to the fourth registered user based on the second at least one seat assignment request.

7. The computer-implemented method of claim 1, further comprising:
receiving a request from the second registered user of the client platform to use the purchased application;
verifying that the second registered user has an assigned seat based on the step of assigning;
sending a clear text version and an accompanying digital signature of the license to the licensing authority to request authorization to use the purchased application from the licensing authority;
receiving authorization to use the purchased application from the licensing authority; and
sending the second registered user the authorization to use the purchased application.

8. The computer-implemented method of claim 1, further comprising:
receiving a request from the second registered user of the client platform to use the purchased application;
verifying that the second registered user has an assigned seat based on the step of assigning;
sending a clear text version and accompanying digital signature of the license to the licensing authority to request use of the purchased application from the licensing authority;
receiving notice from the licensing authority that the license for the purchased application is invalid; and
denying the request from the second registered user to use the purchased application.

9. The computer-implemented method of claim 1, further comprising:
receiving a request from a third registered user of the client platform to use the purchased application;
determining that the third registered user has not been assigned a seat based on the step of assigning;
denying the request from the third registered user to use the purchased application.

10. A system for assigning and enforcing usage rights for a software application, the system comprising:
at least one processor; and
a memory coupled to the at least one processor, the memory comprising computer executable instructions that, when executed by the at least one processor, perform a method of:
receiving at a client platform notice of an application purchase by a purchaser, wherein the purchaser is a first registered user of a client platform;
sending information to a licensing authority wherein the information identifies a software system utilized by the purchaser;
receiving a license for the purchased application from the licensing authority; and
receiving from a license director at least one seat assignment request to enable a second registered user of the client platform to use the purchased application, wherein the second registered user of the client platform is different from the purchaser;
verifying that the at least one seat assignment request is allowable for the purchased application; and
assigning at least one seat assignment to the second registered user based on the at least one seat assignment request.

11. The system of claim 10, further comprising:
receiving a request from the second registered user of the client platform to use the purchased application;
verifying that the second registered user has an assigned seat based on the step of assigning;
sending a clear text version and accompanying digital signature the license to the licensing authority to request authorization to use the purchased application from the licensing authority;
receiving authorization to use the purchased application from the licensing authority; and
sending the second registered user the authorization to use the purchased application.

12. The system of claim 11, further comprising:
sending the license to a verification service;
sending the at least one seat assignment to the verification service;
requesting notice that the sent license is valid from the verification service; and
receiving from the verification service notice that the sent license is valid.

13. The system of claim 11, further comprising:
receiving at the client platform notice of a second application purchase by a second purchaser, wherein the second purchaser is a third registered user of the client platform, and wherein the second purchaser is different from the first purchaser;
sending other information to the licensing authority, wherein the other information identifies a software system utilized by the second purchaser;
receiving a second license for the second purchased application from the licensing authority; and
receiving from a second license director a second at least one seat assignment request to enable a fourth registered user of the client platform to use the purchased application, wherein the fourth registered user of the client platform is different from the second purchaser;
verifying that the second at least one seat assignment request is allowable for the second purchased application; and
assigning at least one seat assignment to the fourth registered user based on the second at least one seat assignment request.

14. The system of claim 10, further comprising:
receiving a request from a third registered user of the client platform to use the purchased application;
determining that the third registered user has not been assigned a seat based on the step of assigning; and
sending the third registered user authorization to use the purchased application with limited functionality based on step of determining that the third registered user has not been assigned a seat.

15. The system of claim 10, wherein the purchased application includes an unlimited number of seat assignments.

16. The system of claim 10, wherein the license is at least one of a time expiring license, a license that requires periodic renewal, and a license that requires automatic renewal.

17. The system of claim 10, further comprising:
requesting periodically to receive a renewed license from the licensing authority; and
receiving from the licensing authority the renewed license including a renewed clear text version and an accompanying digital signature of the license.

18. A computer readable medium comprising of assigning and enforcing usage rights for a software application by utilizing a client platform, the method comprising:
receiving at a client platform notice of a first application purchase by a first purchaser, wherein the first purchaser is a first registered user of a client platform;
sending a deploymentID of the client platform utilized by the first purchaser to a licensing authority;
receiving a first license for the first purchased application from the licensing authority; and
receiving from a first license director a first seat assignment request to enable a second registered user of the client platform to use the first purchased application, wherein the second registered user of the client platform is different from the first purchaser,
wherein the first license director is a website administrator of a website run via the client platform and the first application configured to run on the website;
verifying that the first seat assignment request is allowable for the first purchased application;
assigning a first seat assignment to the second registered user based on the first seat assignment request;
receiving at the client platform notice of a second application purchase by a second purchaser, wherein the second purchaser is a third registered user of the client platform, and wherein the second purchaser is different from the first purchaser;
sending a deployment ID of the client platform utilized by the second purchaser to the licensing authority;
receiving a second license for the second purchased application from the licensing authority; and
receiving from a second license director a second seat assignment request to enable a fourth registered user of the client platform to use the second purchased application, wherein the fourth registered user of the client platform is different from the second purchaser,
verifying that the second seat assignment request is allowable for the second purchased application; and
assigning a second seat assignment to the fourth registered user based on the second seat assignment request

19. The computer readable medium of claim 18, further comprising:
requesting periodically to receive a renewed license from the licensing authority; and
receiving from the licensing authority the renewed license.

20. The computer-implemented method of claim 18, further comprising:
receiving a request from the second registered user of the client platform to use the purchased application;
verifying that the second registered user has an assigned seat based on the step of assigning the first seat assignment;
sending a clear text version and accompanying digital signature version of the license to the licensing authority to request use of the purchased application from the licensing authority;
receiving notice from the licensing authority that the license for the purchased application is invalid; and
denying the request from the second registered user to use the purchased application.
